(19) United States
(12) Patent Application Publication
(10) Pub. No.: US 2013/0036350 A1
(43) Pub. Date: Feb. 7, 2013

(54) MODULAR TOOL FOR CONSTRUCTING A LINK TO A RIGHTS PROGRAM FROM ARTICLE INFORMATION

(71) Applicant: James ARBO, Chelmsford, MA (US)

(72) Inventor: James ARBO, Chelmsford, MA (US)

(73) Assignee: COPYRIGHT CLEARANCE CENTER, INC., Danvers, MA (US)

(21) Appl. No.: 13/197,915

(22) Filed: Aug. 4, 2011

(51) Int. Cl. G06F 17/00

(52) U.S. Cl. 715/234

(57) ABSTRACT

A link to a rights advisor website can be constructed from article metadata by a non-programmer user by connecting together a chain of steps, each of which uses a pre-defined module, called a “widget”, which, in turn, performs a specific task. By selecting, configuring and arranging steps, different websites can be processed in different manners. However, since the modules are predefined, they cannot be changed and thus the overall process can be controlled to prevent problems with one program from affecting other programs.

### BACKGROUND

This invention relates to digital rights display and methods and apparatus for determining reuse rights for content to which multiple licenses and subscriptions apply. Works, or “content”, created by an author is generally subject to legal restrictions on reuse. For example, most content is protected by copyright. In order to conform to copyright law, content users often obtain content reuse licenses. A content reuse license is actually a “bundle” of rights, including rights to present the content in different formats, rights to reproduce the content in different formats, rights to produce derivative works, etc. Thus, depending on a particular reuse, a specific license to that reuse may have to be obtained.

Many organizations use content for a variety of purposes, including research and knowledge work. These organizations obtain that content through many channels, including purchasing content directly from publishers and purchasing content via subscriptions from subscription resellers. Subscriptions generally include some reuse rights that are conveyed to the subscriber. A given subscription service will generally try to offer a standard set of rights across its subscriptions, but large customers will often negotiate with the service to purchase additional rights. Thus, reuse rights may vary from subscription to subscription and the reuse rights available for a particular subscription may vary even across publications within that subscription. In addition, the reuse rights conveyed in these subscriptions often overlap with other rights and licenses purchased from license clearinghouses, or from other sources.

Many knowledge workers attempt to determine which rights are available for particular content before using that content in order to avoid infringing legitimate rights of rightsholders. However, at present, determining what reuse rights an organization has for any given publication is a time-consuming, manual procedure, generally requiring a librarian or legal counsel to review in advance of the use, all license agreements obtained from content providers and purchased from other sources which may pertain to the content and its reuse. The difficulty of this determination means that sometimes an organization will overspend to purchase rights for which it already has paid. Alternatively, knowledge workers may run the risk of infringing a reuse right for which they believe that the organization has a license, but which, in actuality, the organization does not.

Accordingly, organizations, such as the Copyright Clearance Center located in Danvers, Mass., have developed mechanisms that allow knowledge workers to purchase licenses during the search process. In one of these mechanisms, when the worker searching on a publisher's website has navigated to a webpage containing, for example, the content of an article in which the worker is interested, and the worker wants to determine available rights for that article, the worker can click on a link provided on the webpage by the publisher. The link contains a “Rightslink” URL of a rights advisor website and accesses the website. A URL associated with the article is then provided to the website. In response, the rights advisor website extracts all agreements stored therein that are applicable to the organization to which the worker belongs. The rights advisor website converts the URL of the article to a standard publication identifier. The publication identifier is then used to determine agreements that are applicable to that publication. These agreements are processed to determine available rights, terms and prices, which are returned online to the knowledge worker.

However, in some cases, the knowledge worker is not searching on a publisher's website, but on another website which does not include the link to the rights advisor website. For example, the worker may be searching on a website, such as copyright.com, provided by the Copyright Clearance Center. In this case, if the worker requests information on available rights, information identifying an article located by the worker, such as a digital object identifier, is used to locate and access the publisher's webpage for that article. As noted, above, the publisher's webpage contains a link which allows the worker to access the rights advisor webpage and obtain available rights, terms and prices for the article. The Rightslink URL data is then extracted from the publisher's webpage and used to access the rights advisor website to obtain the rights information as disclosed above.

Generally, the Rightslink URL data extraction process involves writing a small software program that is specific to the publisher or clearinghouse whose website is being examined and which processes the website in a manner particular to that website to extract the relevant information. This, in turn, generally involves the services of a programmer and thus the overall process is expensive and may be limited by the availability of programmer resources. It would therefore be desirable if non-programmer personnel could generate the required software code without programmer involvement. However, it is imperative that limitations be placed on the code generation process so that the malfunction of any generated software code does not compromise the entire system or code that extracts data from other websites or return erroneous results to the knowledge worker.

### SUMMARY

In accordance with the principles of the present invention, the website processing code can be constructed by a non-programmer user by connecting together a chain of steps, each of which uses a pre-defined module, called a “widget”, which, in turn, performs a specific task. By selecting, configuring and arranging steps, different websites can be processed in different manners. However, since the modules are predefined, they cannot be changed and thus the overall process can be controlled to prevent problems with one program from affecting other programs.

In one embodiment, each step is defined in XML text. A sequence of steps, also defined in the XML text forms a rule that forms the website processing code.

In another embodiment, the XML text defines property expressions which are provided as input parameters to the associated widget.

In still another embodiment, widgets are implemented as Java classes.

### BRIEF DESCRIPTION OF THE DRAWINGS

FIG. 1 is a block schematic diagram of a system for constructing link from article metadata in accordance with the principles of the invention.

FIG. 2 is a schematic diagram of the properties and methods of a widget using the Executable Widget interface.

FIG. 3 is a page of XML data that implements a first exemplary rule.

FIG. 4 is a page of XML data that implements a second exemplary rule.

FIGS. 5A and 5B, when placed together, form a page of XML data that implements a third exemplary rule.

### DETAILED DESCRIPTION

As set forth above, a pre-written collection, or toolbox, of modules called “widgets”, each of which performs a specific task, is provided by a programming staff. A non-programmer user can then specify inputs to each widget and assemble the widgets into a chain called a “linking rule” which accepts article metadata as inputs and produces a Rightslink URL as an output. The user can then designate a set of works or articles with an existing tagging service and attach the linking rule to this set of works. Subsequently, a knowledge worker searching these works can invoke the linking rule which, in turn, scrapes or otherwise constructs a link that can be used, for instance, to invoke a rights advisor web application to review available content reuse rights.

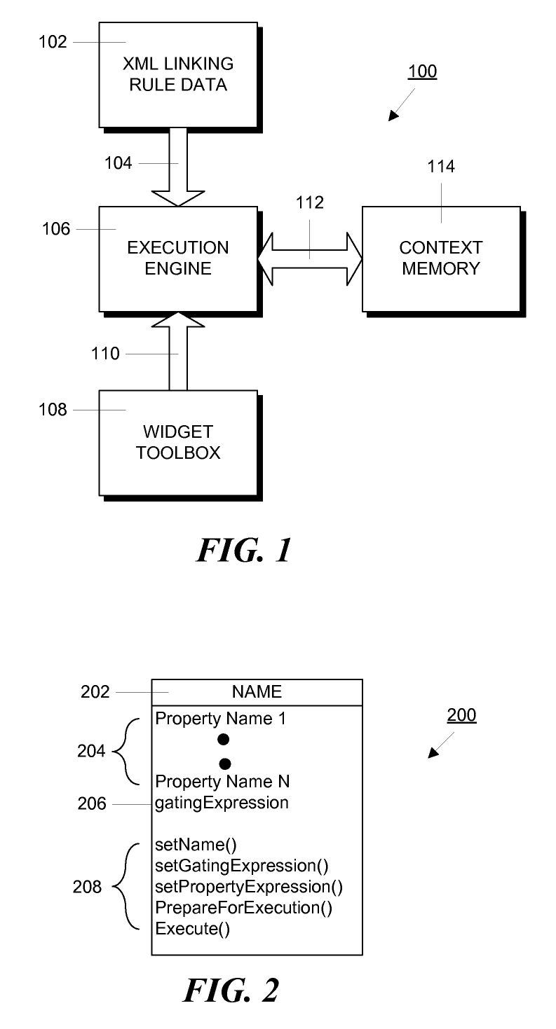

FIG. 1 is a block schematic diagram of the system 100. The system 100 is built on top of an execution engine 106. The purpose of the execution engine 106 is to execute a sequence of one or more steps. The configurable sequence of steps to be executed is called a linking rule and is defined in the XML linking rule data 102 that is applied to the execution engine 106 as indicated schematically by arrow 104.

As defined in the XML data 102, each step specifies a valid widget class name. This name can refer to any widget class that implements the ExecutableWidget interface (discussed below) and exists in the widget toolbox 108. The widget will be executed during execution of the step as schematically illustrated by arrow 110. A step definition also requires a step name, which is a character string value that is used to identify the step so the step properties and result can be referenced in subsequent steps.

Further included are zero or more optional property values that are provided to the widget. These property values can include a list of input parameters including top level arguments provided by the system that invokes the linking rule. These arguments, called context variables, could include, for example, article and work metadata, such as a digital object identifier (DOI). The context variables are stored in the execution engine thread as indicated schematically by context memory 114 and provided to the execution engine 106 as indicated schematically by arrow 112.

Other property values can also include literals, the output from a previous step, and Java Expression Language (JEXL) expressions. JEXL is a well-known open-source library intended to facilitate the implementation of dynamic and scripting features in applications and frameworks. More details can be found at commons.apache.org.

Property values can either be static or dynamic. A static property remains fixed for each execution of the step during execution of a rule. A dynamic property is any valid JEXL expression and is resolved just prior to execution of the widget. This JEXL expression can contain references to context variables and/or other widget properties

A step further defines an optional gating expression which is a JEXL expression that can access properties from any other widget that has already executed and resolves to true or false. An empty expression or any expression that resolves to true will result in the widget associated with the step executing. If the expression resolves to false, the widget will not execute. The expression is resolved at runtime so its result depends on the state of the linking rule for that invocation.

In one embodiment, widgets are implemented as Java classes. Any java class can be a widget as long as it implements an ExecutableWidget interface as defined in Java. FIG. 2 illustrates the components of a widget 200. These include the widget name 202, a set of widget properties 204 and a gating expression 206. The gating expression 206 is the aforementioned JEXL expression that determines whether this widget will be executed during the execution of the linking rule.

The widget further includes a set of methods 206 which are defined as follows:

| Method | Description |
|---|---|
| g/setName( ) | Sets the name of the widget. The name |
| | can be used to identify and access |
| | properties of the widget from any other |
| | widget during rule execution |
| g/setGatingExpression( ) | Sets the gating expression |
| g/setPropertyExpressions(List | Sets the initial value of the properties 204. |
| <PropertyExpression>) | This method references a list of |
| | PropertyExpressions. A |
| | PropertyExpression is an object that |
| | contains a property name and a JEXL |
| | expression. Just before executing a widget, |
| | the execution engine evaluates |
| | each of its PropertyExpressions. The result |
| | of each expression is used to set the value |
| | of the corresponding widget property. |
| | This allows for the determination of |
| | widget property values at runtime. |
| prepareForExecution( ) | This method is called just prior to |
| | executing a widget. widget implementers |
| | can include any code in this method that |
| | must be invoked prior to widget execution. |
| execute( ) | This method is called when the execution |
| | engine executes the widget. It must return |
| | a WidgetResult object. |

An example widget written in the Java programming language that concatenates two character strings is shown below.

```
public class Concat extends BaseWidget implements ExecutableWidget {
  private String part1;
  private String part2;
  @Override
  public WidgetResult execute( ) {
```

```
if (part1 == null) {
  getWidgetResult( ).setFailure(getName( )+“.part1 was null”);
} else if (part2 == null) {
  getWidgetResult( ).setFailure(getName( )+“.part2 was null”);
} else {
  getWidgetResult( ).setSuccess(part1 + part2);
```

}

return getWidgetResult( );

```
  }
  public String getPart1( ) {
```

return part1;

```
  }
  public void setPart1(String part1) {
```

this.part1 = part1;

```
  }
  public String getPart2( ) {
```

return part2;

```
  }
  public void setPart2(String part2) {
```

this.part2 = part2;

}
}

The execution engine 106 will look on the Java classpath for all implementations of the ExecutableWidget interface when it is invoked. The result of a widget can be any java object from the Java classpath and must be wrapped within a WidgetResult object, which is a standard Java object. The WidgetResult object carries additional data about the result. For example, it carries whether the invocation succeeded, failed or was gated. It also contains a reference to the exception if one was raised while executing the widget.

Using a simple graphical user interface, a user can test an individual step by providing its input arguments via the user interface. The system will display the widgets output on the screen. The user can also test a sequence of steps by providing the necessary input arguments. The system will display the output of those steps on the screen.

A user can create a linking rule by selecting one or more widgets from toolbox 108, defining the input arguments for each widget and defining the order of execution. Both the input arguments and the order of execution are determined by means of XML linking rule data that is schematically illustrated as data 102 in FIG. 1. This data can be manipulated via the aforementioned graphical user interface.

The final result of a rule is the same as the result of its final widget. The result is always a Java object and it is always wrapped within a conventional Java WidgetSetResult object. The WidgetSetResult object contains a status field that identifies whether all of the steps successfully executed or whether there was an error during execution.

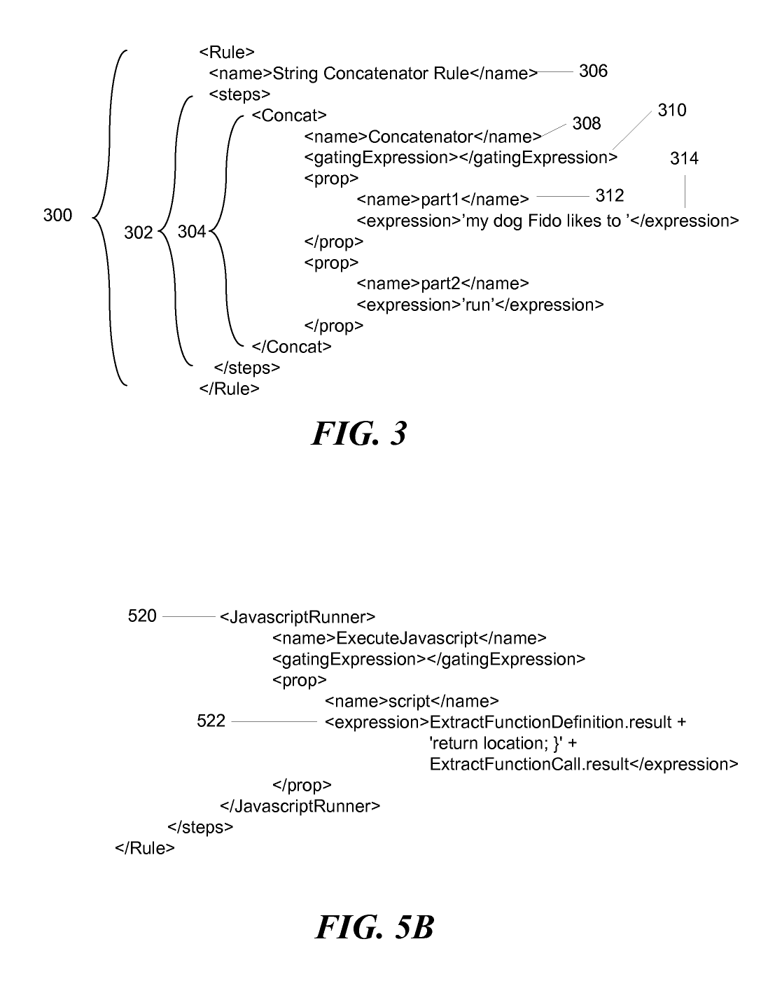

The XML data that defines an example rule 300 is illustrated in FIG. 3. The rule is defined by the parameters appearing between the “Rule” XML tags. The purpose of this rule is to concatenate two character strings, which are provided as property values to the concatenation widget described above. The rule 300 has a name 306 defined by the “Name” XML tags and at least one step defined by the parameters between the “Step” XML tags 302. In this example, there is a single step 304. Each step is defined by XML tags which are the name of the widget associated with the step. The example uses the widget class “Concat” set forth above. Thus, the XML tags are “Concat”. The step 304 includes a name 308 defined by the XML “Name” tags, a gatingExpression 310, defined the “gatingExpression” name tags (which, in this example, is empty) and a set of property expressions defined by the “prop” XML tags. Each property expression has a name 312 and a JEXL based expression value 314. When this rule is executed by the execution engine 106, the property expressions are evaluated by the execution engine 106 which calls in the Concat widget the set<property expression name>( ) method with each of the property expression names and the expression values set forth in the rule XML code. Then the execute( )method of the widget is called. Execution of the rule shown in FIG. 3 returns an instance of java.lang.string containing the text ‘my dog Fido likes to run’.

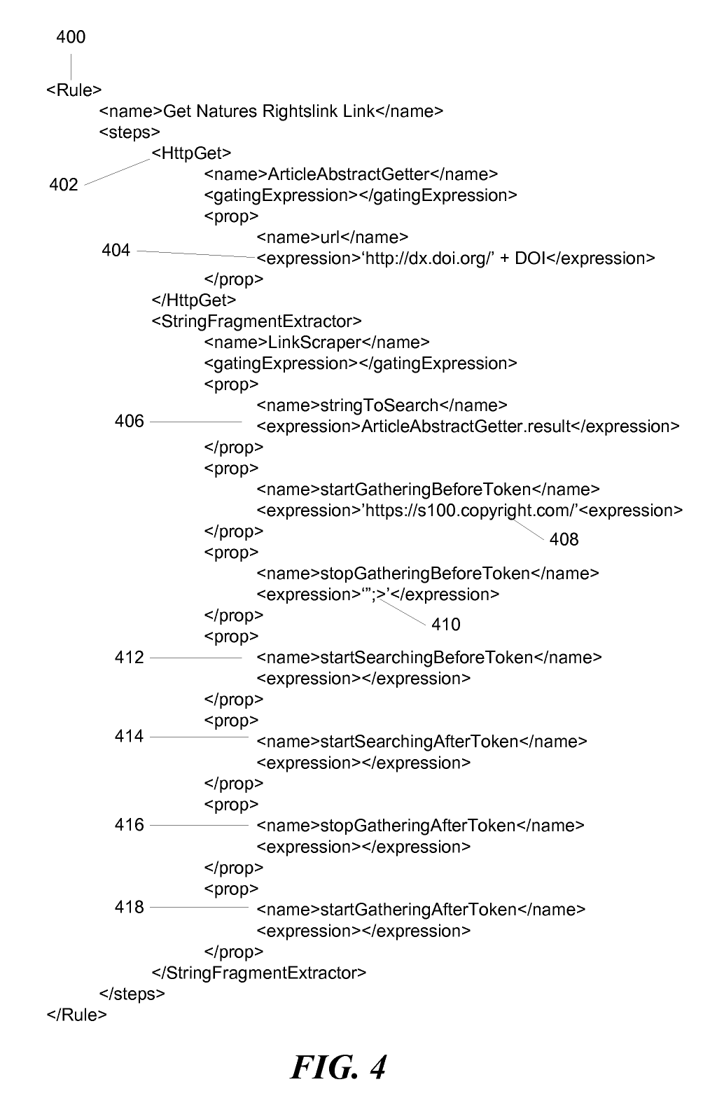

The XML data for a more complicated rule is shown in FIG. 4. This rule scrapes a Rightslink link from a web page. The rule comprises two steps. The first step retrieves a target web page on which the link is located. This is performed by the ArticleAbstractGetter step which builds a URL to the target page using article metadata, in this case, the article DOI. This DOI value is expected to be a first-level variable in the execution Context which is provided by the calling program and stored in the context memory 114 (FIG. 1). This step first builds a URL property expression 404 using a URL corresponding to the International DOI Organization and concatenating the article DOI value. The HpptGet Widget then is executed. This Widget accesses the doi.org website and fetches the target page HTML from the website without displaying it.

Then, the LinkScraper step is executed. This step uses the StringFragmentExtractor Widget which extracts a string from a search string. The stringToSeach property expression 406 is set to the result of the previous step. At runtime this result contains the HTML code that was retrieved from the doi.org website by the ArticleAbstractGetter step. The startGatheringBeforeToken property value specifies the position in the HTML code at which the StringFragmentExtractor Widget begins extracting characters. This property value is set to a string constant 408 identifying where to start extracting characters. Characters are extracted until the stopGatheringBeforeToken property value is reached. This latter property value is set to another string constant 410. Other property values 412-418 which may be used in other situations are left blank and are not used in this rule. The result of executing the above rule is a java.lang.string containing the characters that form the Rightslink URL. This URL can then be used to access the rights advisor website and retrieve the available rights.

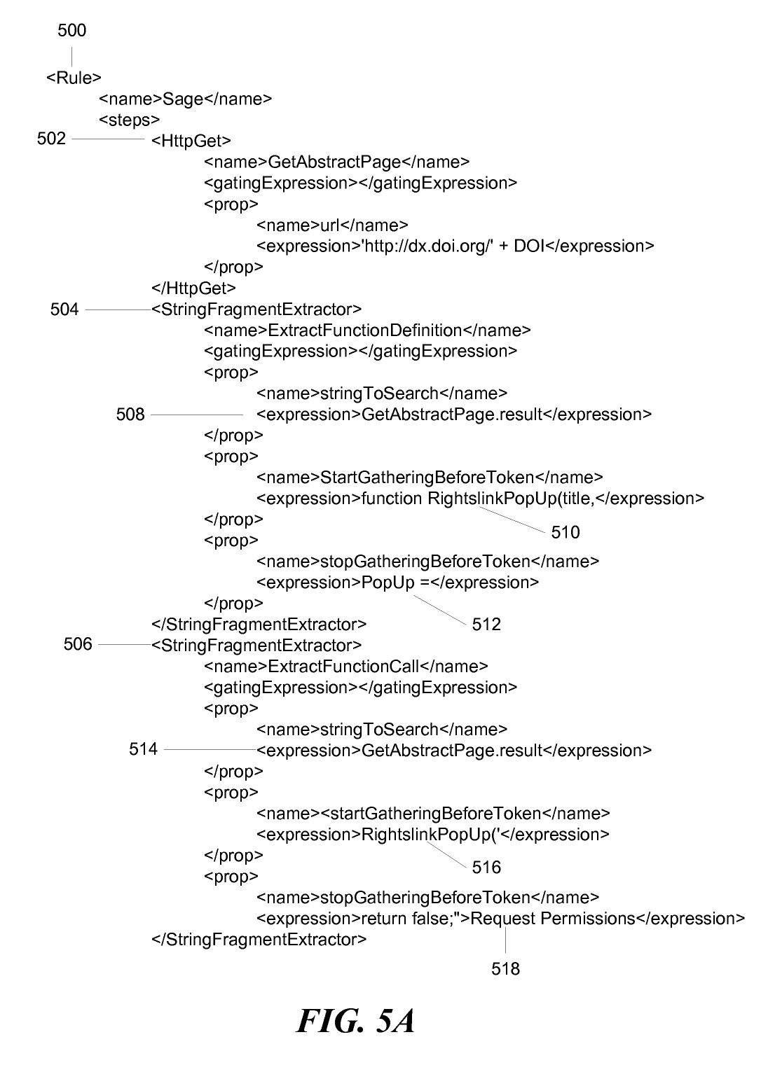

The XML data defining another example rule is shown in FIGS. 5A and 5B, which when placed together form an XML code page. The rule shown in FIGS. 5A and 5B also builds a Rightslink link. The difference between this rule and the rule shown in FIG. 4 is that this rule processes a target web page that does not contain a Rightslink link as a static string so the StringFragmentExtractor Widget cannot be used to directly extract the link. On the target web page in question, the Rightslink link is constructed using Javascript on the web page. Therefore, the rule must invoke that Javascript to obtain the link.

Rule 500 also uses a GetAbstractPage step 502 which, similar to the ArticleAbstractGetter step shown in FIG. 4, builds a URL to a target page using the article DOI. During the execution of this step, the HpptGet Widget is executed and accesses the doi.org website in order to fetch the target page HTML from the website without displaying it.

Next, the Javascript function definition and function call are extracted from the retrieved web page HTML code by two steps, the ExtractFunctionDefinition step 504 and the ExtractFunctionCall step 506. Both of these steps use the StringFragmentExtractor Widget to selectively extract character strings from the HTML code. For example, step 504 extracts characters from the result of the GetAbstractPage step 502 as indicated at 508. The startGatheringBeforeToken property value specifies the position in the HTML code at which the StringFragmentExtractor Widget begins extracting characters. This property value is set to a string constant 510 identifying where to start extracting characters. Characters are extracted until the stopGatheringBeforeToken property value is reached. This latter property value is set to another string constant 512.

Similarly, step 506 extracts characters from the web page HTML as indicated at 514. The startGatheringBeforeToken property value is set to a string constant 516 identifying where to start extracting characters. Characters are extracted until the stopGatheringBeforeToken property value is reached. This latter property value is set to another string constant 518.

At this point, both the Javascript function definition and function call have been extracted. The Javascript is then run in step 520 which uses a JavascriptRunner widget, which can run Javascript from within Java using a third party library called “Rhino”. The step assembles the function definition, the return value and the function call using the results of the ExtractFunctionDefinition step 504 and the ExtractFunctionCall step 506 and the JEXL concatenation operator “+” and then runs the Javascript. The result is a java.lang.string containing the characters that form the Rightslink URL.

An exemplary list of Widgets which can be used to process many web pages is set forth below:

| | |
|---|---|
| Test | Takes an JEXL expression and returns true or |
| | false depending on the value of the expression |
| Concat | Takes 2 input strings and returns them as a |
| | single concatenated string |
| CookieSetter | Takes a domain, path, and value and sets a |
| | cookie on the active HttpClient |
| FormSubmitter | Takes a chunk of html that describes a form, |
| | an action URL, and form field values. It then |
| | performs an HTTP post to the action URL |
| | along with the specified form field values. |
| | This Widget ultimately returns the html that |
| | was returned as a result of posting the form. |
| FormToURL | This Widget converts a block of form html into |
| | an equivalent Get request URL. The new |
| | URL is returned as a string. |
| Getter | This widget accepts an http URL and performs |
| | an HTTP GET. It returns a string containing |
| | the page html that was returned by the |
| | http server. |
| HttpURLDecoder | This widget takes a string and returns the |
| | same string after decoding the characters. |
| JavascriptRunner | This widget takes a block of |
| | Javascript, executes it, and returns the result. |
| KeyValueMapper | This widget takes a string and returns |
| | a corresponding value from a database table. |
| StringFragmentExtractor | This widget extracts one string |
| | from another and returns the substring. |
| StringReplacer | This widget replaces one string within a |
| | second string with a third string. The resulting |
| | string is returned. |

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. A modular tool for constructing a link to a rights program from article information, comprising:
a plurality of pre-defined modules, each of which accepts an input and contains program code that can be executed to generate an output from the input, at least one module of the plurality of modules accepting the article information as an input;
a data file for specifying at least one input to each module and for specifying an execution order of the modules; and
an execution engine that executes program code contained in each of the modules using the input specified by the data file and in the order specified by the data file, wherein a module which is executed last generates the link as an output.

2. The modular tool of claim 1 wherein each module is implemented as a Java class with predefined properties and predefined methods.

3. The modular tool of claim 1 wherein the data file is an XML data file.

4. The modular tool of claim 3 wherein the XML data file defines property expressions associated with a module which generate input parameters to that module.

5. The modular tool of claim 4 wherein property expressions associated with a module are evaluated by the execution engine prior to executing the program code contained in the module.

6. The modular tool of claim 3 wherein the XML data file defines a gating expression for a module and wherein the execution engine evaluates the gating expression for a module to determine whether to execute the program code of that module.

7. The modular tool of claim 1 wherein inputs to a module comprise at least one of the group consisting of the article information, literal expressions, an output from another module, and Java Expression Language expressions.

8. The modular tool of claim 1 wherein at least one module contains program code that is executed by the execution engine to access an http server and retrieve web page html code for a web page corresponding to an http URL provided to the program code.

9. The modular tool of claim 8 wherein at least one module contains program code that is executed by the execution engine to extract the link from the retrieved web page html code.

10. The modular tool of claim 8 wherein at least one module contains program code that is executed by the execution engine to extract javascript from the retrieved web page html code and to run the extracted javascript in order to obtain the link.

11. A method for use on a computer with a processor and a memory, the method constructing a link to a rights program from article information and comprising:
(a) providing and controlling the processor to store in the memory a plurality of pre-defined modules, each of which accepts an input and contains program code that can be executed to generate an output from the input, at least one module of the plurality of modules accepting the article information as an input;
(b) providing and controlling the processor to store in the memory a data file for specifying at least one input to each module and for specifying an execution order of the modules; and
(c) controlling the processor to execute program code contained in each of the modules using the input specified by the data file and in the order specified by the data file, wherein a module which is executed last generates the link as an output.

12. The method of claim 11 wherein step (a) comprises implementing each module as a Java class with predefined properties and predefined methods.

13. The method of claim 11 wherein step (b) comprises providing the data file as an XML data file.

14. The method of claim 13 wherein the XML data file defines property expressions associated with a module which generate input parameters to that module.

15. The method of claim 14 wherein step (c) comprises evaluating property expressions associated with a module prior to executing the program code contained in the module.

16. The method of claim 13 wherein the XML data file defines a gating expression for a module and wherein step (c) comprises evaluating the gating expression for a module to determine whether to execute the program code of that module.

17. The method of claim 11 wherein inputs to a module comprise at least one of the group consisting of the article information, literal expressions, an output from another module, and Java Expression Language expressions.

18. The method of claim 11 wherein step (a) comprises providing at least one module containing getter program code that accesses an http server and retrieves web page html code and step (c) comprises providing an http URL as an input to, and executing, the getter program code to retrieve the web page html code from a web page corresponding to the URL.

19. The method of claim 18 wherein step (a) comprises providing at least one module that contains scraping program code that extracts a link from web page html code and step (c) comprises executing the scraping program code to obtain the link from the retrieved web page html code.

20. The method of claim 18 wherein step (a) comprises providing at least one module that contains javascript program code that extracts javascript from web page html code and runs the extracted javascript and step (c) comprises executing the javascript program code to extract and run javascript from the retrieved web page html code to obtain the link.
